(19) United States
(12) Patent Application Publication
(10) Pub. No.: US 2004/0064339 A1
(43) Pub. Date: Apr. 1, 2004

(54) Method, apparatus, and computer program for generating albums

(76) Inventors: Kazuo Shiota, Tokyo (JP); Kiyotaka Kaneko, Kanagawa-ken (JP)

Correspondence Address: BIRCH STEWART KOLASCH & BIRCH, PO BOX 747, FALLS CHURCH, VA, 22040-0747, US

(21) Appl. No.: 10/669,593

(22) Filed: Sep. 25, 2003

(30) Foreign Application Priority Data
Sep. 27, 2002 (JP) 2002-282632

(51) Int. Cl. G06F 17/60

(52) U.S. Cl. 705/1

(57) ABSTRACT

Albums are generated by efficiently classifying images recorded on a high capacity memory card. Image datasets, having location data representing photography locations thereof attached thereto, are transmitted from a personal computer to an album generation support server. The album generation support server calculates distances between the photography locations of the image datasets and a predetermined reference position, such as the user's home, based on the location data. In cases that the distance exceeds a predetermined threshold value, the image dataset is assumed to have been photographed during a trip, and is classified as an image for a vacation album. In cases that the distance does not exceed the threshold value, the image dataset is assumed to have been photographed in the vicinity of the user's home, and classified as an image for a theme album, the theme being an event that occurs in the vicinity of the user's home.

### BACKGROUND OF THE INVENTION

1. Field of the Invention

The present invention relates a method and apparatus for generating an album based on image data photographed by a digital camera. The present invention also relates to a computer program that causes a computer to execute the method for generating the album.

2. Description of the Related Art

Albums classified according to themes are being generated based on image data photographed by digital cameras. Examples of these albums are: vacation albums classified according to destinations of trips; albums having photographs taken at athletic events at school or kindergarten; albums having photographs taken at a birthday party in a user's home; and albums having photographs taken at a Christmas party. Particularly with regard to generating vacation albums, a system for generating digital albums of this type, wherein image data sets which have, for example, data describing date and time of photography in their tag information, is interfaced with a layout database, which contains maps, coordinates on the maps, arrival time and departure time, has been proposed (refer to Japanese Unexamined Patent Publication No. 10 (1998)-126731). In this system, image data sets and a map is attached to a layout selected from the layout database. This system enables easy generation of vacation albums, while eliminating mistakes such as misplacement of photographs.

Meanwhile, the memory capacity of memory cards for storing image data sets in digital cameras continues to increase. It is foreseen that memory cards having memory cards on the order of several gigabytes will be provided in the near future. By employing these high capacity memory cards, it will be possible to photograph a great number of image data sets recorded in recording modes that obtain high quality images. Therefore, it will be possible to generate albums having high image quality.

A 128 MB memory card enables photography of 398 image frames in a recording mode that obtains images of 1280×960 pixels, which is a sufficiently high image quality for viewing on a monitor. In the case of a 1 GB memory card, approximately 3,200 image frames can be recorded therein. Further, in the case of an 8 GB memory card, approximately 25,000 image frames can be recorded therein.

However, as the number of image data sets recorded in a memory card increases, frequent organization of the image data sets becomes necessary, or else a great number of image data sets photographed over an extremely long period of time become recorded therein. In this case, classification of the image data sets becomes extraordinarily troublesome. For this reason, because locating the image data sets necessary for generating an album is time consuming, the organization of the image data sets is put off. The number of recorded image data sets increases further, and the classification thereof becomes that much more difficult.

### SUMMARY OF THE INVENTION

The present invention has been developed in view of the circumstances described above. It is the object of the present invention to enable efficient classification of a great number of image data sets during album generation.

The album generation method according to a first aspect of the present invention is a method for generating an album based on album data including at least one image data set, which has been photographed during a trip and which has location data representing a photography location attached thereto, comprising the steps of:

calculating a distance between the photography location of the image data set and a predetermined reference position, based on the location data;

judging whether the distance is over a predetermined threshold value;

classifying the image data set according to the result of judgment; and

generating the album data according to the result of classification.

Image data sets obtained by a digital camera with a GPS function has GPS data, which represents the photography location, attached thereto. In these cases, GPS data attached to the image data sets can be employed as the location data. Note that the GPS data is not limited to that obtained by a GPS means built in to the camera. The GPS data may be obtained by a separate portable GPS device, or a vehicle navigation system mounted in an automobile, then attached to the image data sets.

Note that cellular telephones receive location data, which represents their locations, from base stations. Accordingly, the location data received by a cellular telephone may be input into the digital camera during photography to attach the location data to the image data sets.

The “predetermined reference position” is a position which is the reference during calculation of the distance therefrom to the photography location of the image data sets. The “predetermined reference position” maybe the home or office of the user of the digital camera, for example.

Note that the method for generating albums according to a second aspect of the present invention further comprises the steps of:

generating travel route data, which represents a route taken during the trip, based on the location data attached to the at least one image data set for which the distance is over the predetermined threshold value;

obtaining a map data set that contains the route from a map database which stores a plurality of map data sets, based on the travel route data;

generating photography data which represents that the image data set was obtained at the photography location along the route;

attaching the photography data to the map data set; and

generating album data including the map data set, in which the photography data is correlated with the image data set.

“Travel route data” is data that represents a route taken from a departure point, such as the user's home, to a final destination.

The travel route data can be generated by tracing the route along which the image data sets were photographed, based on the location data attached thereto. Alternatively, input by a manual operation may be received regarding what route was taken to reach a final destination, and the travel route data may be generated based on the input data.

The “map database” records therein a plurality of map data sets. The “plurality of map data sets” is not limited to data that represent maps of Japan, but may include data representing maps of each country in the world at different scales. The “plurality of map data sets” may further include data representing maps that indicate routes corresponding to various method of travel, such as by rail, by automobile, by bicycle, by ship, by plane, and on foot. As railways and roads change over time, a plurality of map data sets corresponding to different time periods may be recorded in the map database.

The “photography data” refers to data that enables one who views the album data to recognize that an image data set was obtained at the position to which the photography data is attached. Specifically, the photography data maybe a line that connects a thumbnail image of an image data set with a photography location on a map, when the map and the thumbnail image are displayed together. Alternatively, the photography data may be a mark, plotted on a reduced map indicating the photography location of an image data set. The reduced map is contained within the data file of the image data set as a thumbnail image in Exif format, or attached as a thumbnail image combined with a thumbnail image of the image data set, to the image data set. As a further alternative, icons attached to the photography locations may be employed as the photography data.

“The photography data and the image data set are correlated” refers to enabling recognition of the contents of the image data set, which was photographed at the photography location. Specifically, a line may connect a thumbnail image with a photography location thereof on a map. Alternatively, the photography data may be plotted as a mark on a reduced map, which is contained within the data file of an image data set as an Exif format thumbnail image, or plotted as a mark on a reduced map in combination with a thumbnail image of the image data set, which is attached to the image data set. As a further alternative, icons may be attached to the photography locations on a map, to enable reproduction of the image data sets corresponding thereto when the icons are clicked.

The generated album data may be stored on a web site, be recorded in a writable medium such as a CD-R, DVD-R, or a memory card, be displayed on a monitor, or be immediately reproduced by being printed out.

Note that the method for generating an album according to a third aspect of the present invention further comprises the steps of:

obtaining related data, which is related to the photography location of the at least one image data set for which the distance is over the predetermined threshold value, based on the location data attached thereto, from a related data storage means which stores a plurality of related data sets; and

generating album data, which includes the related data.

The “related data” may be an image data set photographed by a third party at the photography location or the vicinity thereof. The “related data” may alternatively be audio data of music or sounds distinct to the photography location or the vicinity thereof, obtained by recording at the photography location or the vicinity thereof in advance or the like. The “related data” may also be text data describing the photography location or the vicinity thereof, in the case that the photography location or the vicinity thereof is site of historic interest or the like. Note that in the case that the “related data” is an image data set photographed by a third party, it is preferable that the image data set be one that is not usually obtainable. Examples of such image data sets are: that which has been photographed by a professional photographer; an aerial photograph; and a bird's eye view photograph. In addition, the image data set is not limited to still images, and may include video data that represents moving images.

In addition, the method for generating an album according to a fourth aspect of the present invention generates album data according to predetermined themes, for the at least one image data set for which the distance is less than or equal to the predetermined threshold value.

Image data sets for which the distance between the photography location and the predetermined reference position is less than or equal to the predetermined threshold value are generally classified according to events, rather than trips, per se. Examples of these events are: a birthday party given at the user's home, a Christmas party, an athletic event held at the school or the kindergarten that the user's children attend, and a school play. The “predetermined themes” refer to events having a high probability of occurrence in the vicinity of the predetermined reference position.

The album generating apparatus according to a first aspect of the present invention is an album generating apparatus that generates album data including at least one image data set, which has been photographed during a trip and which has location data representing a photography location attached thereto, comprising:

a distance calculating means for calculating a distance between the photography location of the image data set and a predetermined reference position, based on the location data;

judgment means for judging whether the distance is over a predetermined threshold value;

classification means for classifying the image data set according to the result of judgment; and

album data generating means for generating the album data according to the result of classification.

Note that the album generating apparatus according to a second aspect of the present invention further comprises:

travel route data generating means for generating travel route data, which represents a route taken during the trip, based on the location data attached to the at least one image data set for which the distance is over the predetermined threshold value;

map data set obtaining means for obtaining a map data set that contains the route from a map database which stores a plurality of map data sets, based on the travel route data;

photography data generating means for generating photography data which represents that the image data set was obtained at the photography location along the route; and

photography data attaching means for attaching the photography data to the map data set; wherein

the album data generating means generates album data including the map data set, in which the photography data is correlated with the image data set.

In addition, the album generating apparatus according to a third aspect of the present invention further comprises:

related data obtaining means for obtaining related data, which is related to the photography location of the at least one image data set for which the distance is over the predetermined threshold value, based on the location data attached thereto, from a related data storage means which stores a plurality of related data sets; wherein

the album data generating means generates album data, which includes the related data.

Further, in the album generating apparatus according to a fourth aspect of the present invention, the album data generating means generates album data according to predetermined themes, for the at least one image data set for which the distance is less than or equal to the predetermined threshold value.

Note that the method for generating an album according to the present invention may be provided as a program that causes a computer to execute the method. The program may be provided on a computer readable medium.

According to the method and apparatus for generating albums of the first aspect of the present invention, a distance is calculated between a photography location of an image data set and a predetermined reference point. Then, a judgment is made as to whether the calculated distance exceeds a predetermined threshold value. Further, the image data set is classified according to the judgment result, and album data is generated according to the classification result. Therefore, even if a great number of image data sets are recorded in a high capacity memory card of a digital camera, the image data sets can be efficiently classified according to the distance of their photography locations from the predetermined reference position. Thereby, album generation is facilitated.

According to the method and apparatus for generating albums of the second aspect of the present invention, travel route data, which includes data related to the route taken during a trip is generated, for image data sets for which the photography locations are at distances from the predetermined reference position exceeding a predetermined threshold value. Then, a map data set that includes the travel route is obtained from a map database, based on the travel route data. Thereafter, photography data which represents that the image data set was obtained at the photography location along the route is generated and attached to the map data set, and album data including the map data set, in which the photography data is correlated with the image data set, is generated.

Therefore, image data sets are easily correlated to the photography locations thereof, along a travel route on a map, represented by the map data set. Accordingly, the image data sets and the photography locations are easily correlated, thereby enabling easy generation of album data.

According to the method and apparatus for generating albums of the third aspect of the present invention, related data sets, related to the photography locations of image data sets, are obtained from a related data storage means which stores a plurality of related data sets, for image data sets of which photography locations are at distances from the predetermined reference position exceeding the predetermined threshold value. The album data is generated, including the related data.

Thereby, data related to the photography locations of the image data set may also be included in the album data, in addition to the image data sets photographed by the user. Accordingly, the contents of the album can be enriched.

According to the method and apparatus for generating albums of the fourth aspect of the present invention, album data is generated according to predetermined themes, for image data whose photography locations are at distances from the predetermined reference position less than or equal to the predetermined threshold value. Therefore, albums corresponding to events which have a high probability of occurrence in the vicinity of the predetermined reference position can be easily generated.

### BRIEF DESCRIPTION OF THE DRAWINGS

FIG. 1 is a schematic block diagram showing the construction of an album generation system in which an album generating apparatus according to an embodiment of the present invention is employed.

FIG. 2 is a flow chart showing the classification processes which are performed during album generation by the embodiment of FIG. 1.

FIG. 3 shows an initial screen of image management software.

FIG. 4 shows a transmission screen.

FIG. 5 is a flow chart showing a classification process.

FIG. 6 shows a selection screen.

FIG. 7 is the first part of a flow chart showing the processes performed during generation of a vacation album by the embodiment of FIG. 1.

FIG. 8 is the second part of a flow chart showing the processes performed during generation of a vacation album by the embodiment of FIG. 1.

FIG. 9 is the third part of a flow chart showing the processes performed during generation of a vacation album by the embodiment of FIG. 1.

FIG. 10 is the fourth part of a flow chart showing the processes performed during generation of a vacation album by the embodiment of FIG. 1.

FIG. 11 shows a classified image display screen for image data sets employed for generation of a vacation album.

FIG. 12 shows a map display screen.

FIG. 13 shows a third party image screen.

FIG. 14 shows a spot data display screen.

FIG. 15 shows an album display screen.

FIG. 16 shows the detailed layout of an album displayed in an album display frame.

FIG. 17 shows an album having a different layout.

FIG. 18 shows the layout of a printed album.

FIG. 19 is a flow chart showing the processes performed during generation of an album according to a theme.

FIG. 20 shows a classified image display screen for image data sets employed for generation of an album according to a theme.

FIG. 21 shows an album display screen.

### DESCRIPTION OF THE PREFERRED EMBODIMENTS

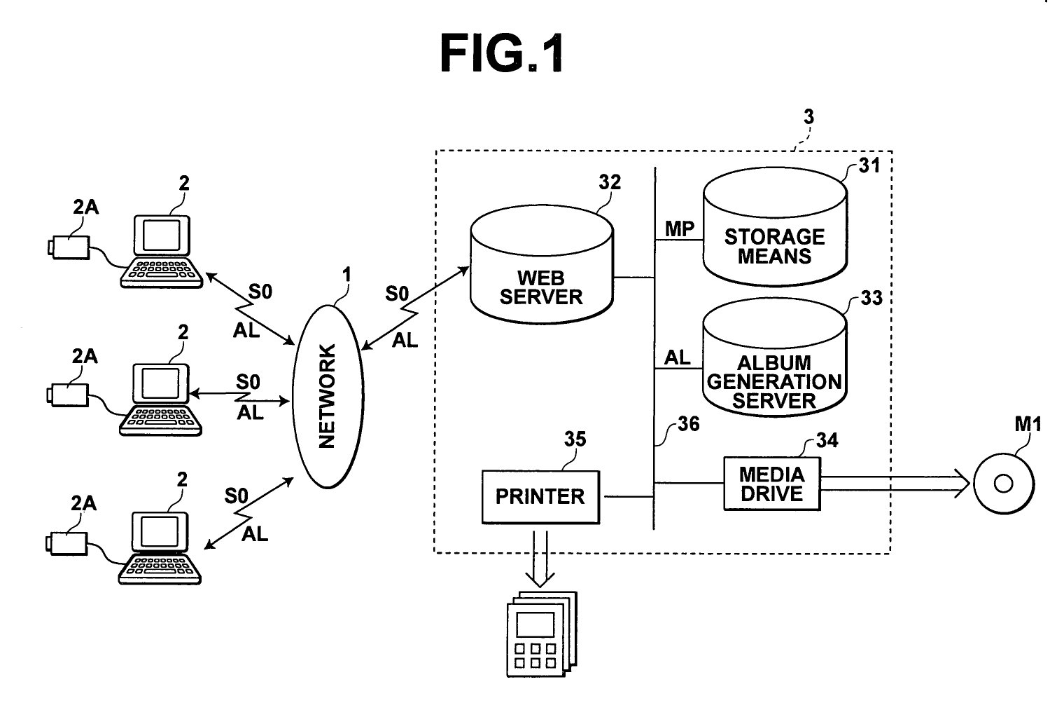

Hereinafter, an embodiment of the present invention will be described with reference to the attached drawings. FIG. 1 is a schematic block diagram showing an album generating system employing an album generating apparatus according to an embodiment of the present invention. As shown in FIG. 1, the album generating system of the present invention comprises: a network 1, such as the Internet; a personal computer 2 of a user who desires to generate an album, for performing various procedures to generate the album as will be described later, connected to the network 1; and an album generation support server 3, for storing image data sets S0 transmitted via the network 1 and for generating the album, also connected to the network 1. Data is exchanged among the constituent components of the album generating system.

Regarding the present embodiment, a user, who desires to generate an album, transmits image data sets S0 and information necessary for album generation from the personal computer 2 to the album generation support server 3. The album generation support server 3 employs the image data sets S0 to generate album data AL, which represents the album.

Note that regarding the present embodiment, the image data sets S0 are assumed to have been photographed by a digital camera owned by the user. Here, tag information attached to the image data sets S0 include time data that represents dates and times of photography. In addition, the digital camera owned by the user is provided with a GPS means for receiving GPS data. Image data sets photographed by the digital camera have GPS data representing the latitude and longitude of the photography location, obtained by the GPS means, attached thereto as location data.

Alternatively, there are cases in which a cellular telephone is connected to a digital camera, and data representing the location of the cellular telephone, transmitted from a base station of a cellular network, is input to the digital camera. In this case also, the location data is attached to the image data sets S0.

A card reader 2a, for reading out the image data sets S0, which have been photographed by the digital camera, from a memory card, is connected to the personal computer. Image management software, for managing the image data sets S0, is installed in the personal computer 2. The image management software communicates with the album generation support server 3, and has a web browsing function, for displaying web pages for album generation. The user accesses a web site of the album generation support server 3 by employing the image management software. Commands for generating the album data AL are input by a function of the image management software that enables input of commands to web sites.

The album generation support server 3 comprises: a storage means 31 for storing various types of data and information, constituted by a high capacity hard disk; a web server 32 for managing the web site of the album generation support server 3, connected to the network 1; an album generation server 33 for generating the album data AL based on the image data sets S0 transmitted from the personal computer 2; a media drive 34 for recording the album data AL onto media M1, such as a CD-R or a DVD-R; a printer 35 for printing out the album data AL; and a bus 36 for connecting all of the constituent components of the album generation support server 3.

The storage means 31 has recorded therein: the image data sets S0 transmitted from the user's personal computer 2 via the network 1; various templates for laying out the image data sets S0 to generate an album; a map database DB1 for managing a plurality of map data sets MP that represent maps, to be described later; generated album data AL; user data regarding a user who accesses the album generation support server 3; software and the like, which are necessary for the generation of travel route data, which represents travel routes, to be described later; and various types of data necessary for the album generation support server 3 to perform the processes involved in album generation and the like.

The templates stored in the storage means 31 are those which are suitable for generating albums for vacation albums, and those suitable for generating albums based on various themes. The themes include: a birthday party or a Christmas party given in the user's home; athletic events at a school or a kindergarten; school plays; and the like.

The storage means 31 also has recorded therein image data sets (referred to as “third party images” to distinguish them from the image data sets S0 photographed by the user) photographed by a professional photographer at various positions along the travel route on a map. The third party images may also be aerial photographs, bird's eye view photographs, or other image data sets not obtainable by usual photography. The third party images are provided in consideration of cases in which the user forgot to photograph certain spots along the travel route, or in cases that photography was prohibited at certain spots along the travel route. Further, the storage means 31 has recorded therein spot data, such as: text data describing various positions on the map, which are sites of historic interest or the like; and audio data of music or sounds distinct to various positions on the map, such as indigenous folk songs. Note that the third party images and the spot data are stored in the storage means 31, correlated with data representing their locations on the map (for example, latitude and longitude).

The map database DB1 has recorded therein a plurality of map data sets MP. Specifically, the plurality of map data sets MP includes map data sets MP that represent maps of Japan, as well as map data sets MP representing maps of each country in the world at different scales. The plurality of map data sets MP further include map data sets MP representing maps that indicate routes corresponding to various method of travel, such as by rail, by automobile, by bicycle, by ship, by plane, and on foot. As railways and roads change over time, a plurality of map data sets MP corresponding to different time periods are recorded in the map database DB1. Further, map data sets MP that clearly indicate train routes, highways, hiking trails, and the like are recorded in the map database DB1. These map data sets MP are provided so as to enable the preferences of a user that desires generation of album data AL to be reflected in the album data AL.

The user data includes: the user's name; a user ID; a password; the user's address; the user's telephone number; the user's age; and the user's profession. The user data further includes the user's interests (for example, road trips, travel by rail, travel abroad). The user data enables estimation of the user's preferences. Note that in the present embodiment, the latitude and longitude of the user's home is derived from the user's home address, and is included in the user data. Here, the user data is that which has been input by the user and transmitted from the personal computer 2 to the album generation support server 3, during registration of the user with the album generation support server 3.

Note that in case a user attempts to access the album generation support server 3, user authentication is performed by prompting the user for a user ID and a password. Access to the album generation support server 3 is permitted only for authenticated users.

The web server 32 manages the web site of the album generation support server 3. The web server 32 also generates web pages to be displayed at the personal computer 2 during generation of album data AL, and transmits the web pages to the personal computer 2. The web pages serve as interfaces to enable the user to perform: selection of image data sets S0 for generating the album data AL; transmission of the image data sets S0 to the album generation support server 3; input of information necessary for generating the album data AL; and the like. The web page also displays the generated album data AL. The web server 32 also performs authentication of users who access the album generation support server 3.

The album generation server 33 generates album data AL based on commands from the personal computer 2. Note that the processes performed by the album generation server 33 will be described later.

The media drive 34 records the generated album data AL onto various types of media M1, such as CD-R's, DVD-R's, and memory cards.

The printer 35 prints out the generated album data AL as albums. The printed albums are bound and given to the user.

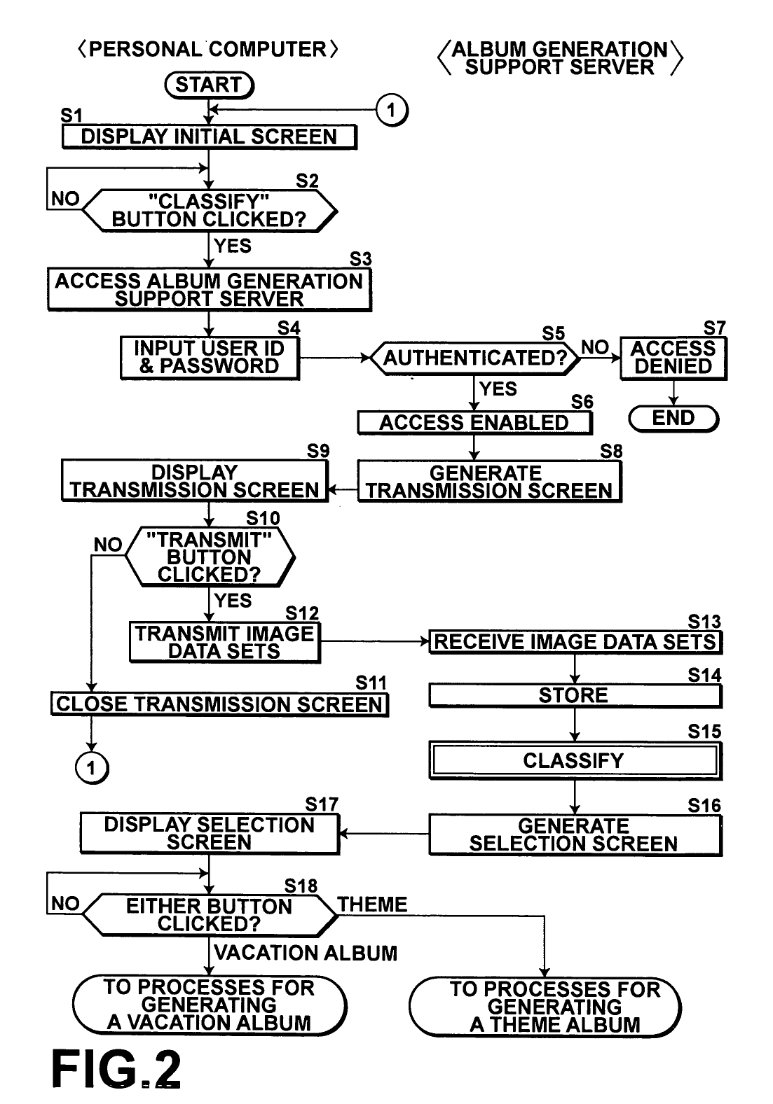

Next, the processes performed by the present embodiment will be described. FIG. 2 is a flow chart that shows the classification process performed by the present embodiment during generation of album data AL. Note that it is assumed that the user has imported image data sets S0, which have been photographed by the digital camera, into the personal computer 2, from the card reader 2a. In addition, it is assumed that the user is running the image management software on the personal computer 2, and that generation of album data AL is performed by accessing the album generation support server 3 via the image management software.

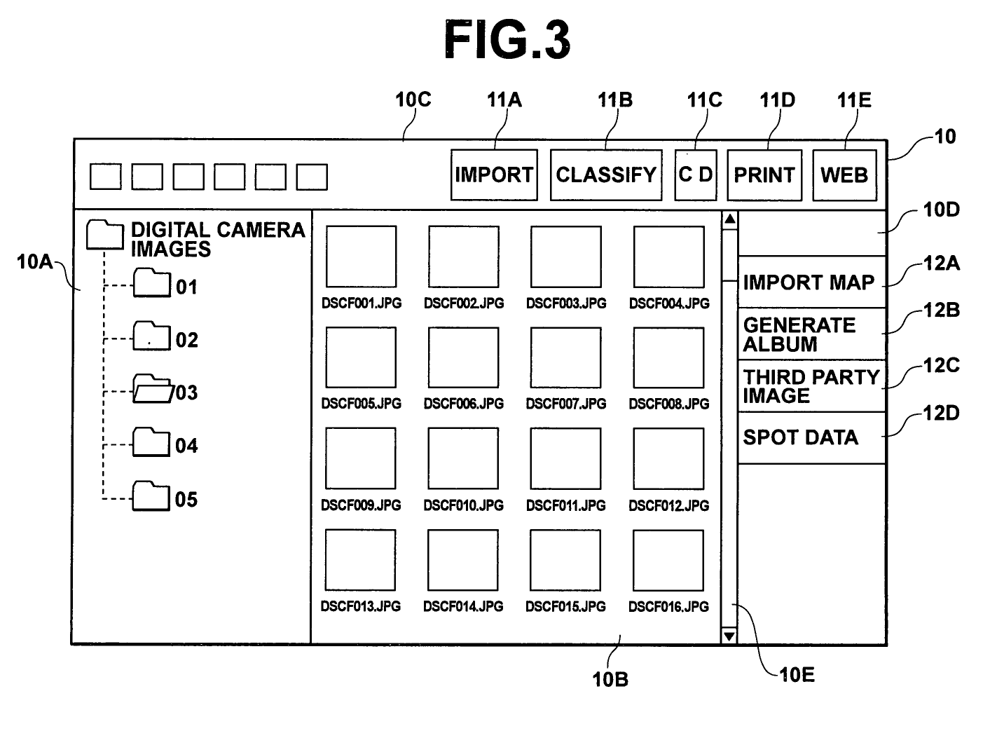

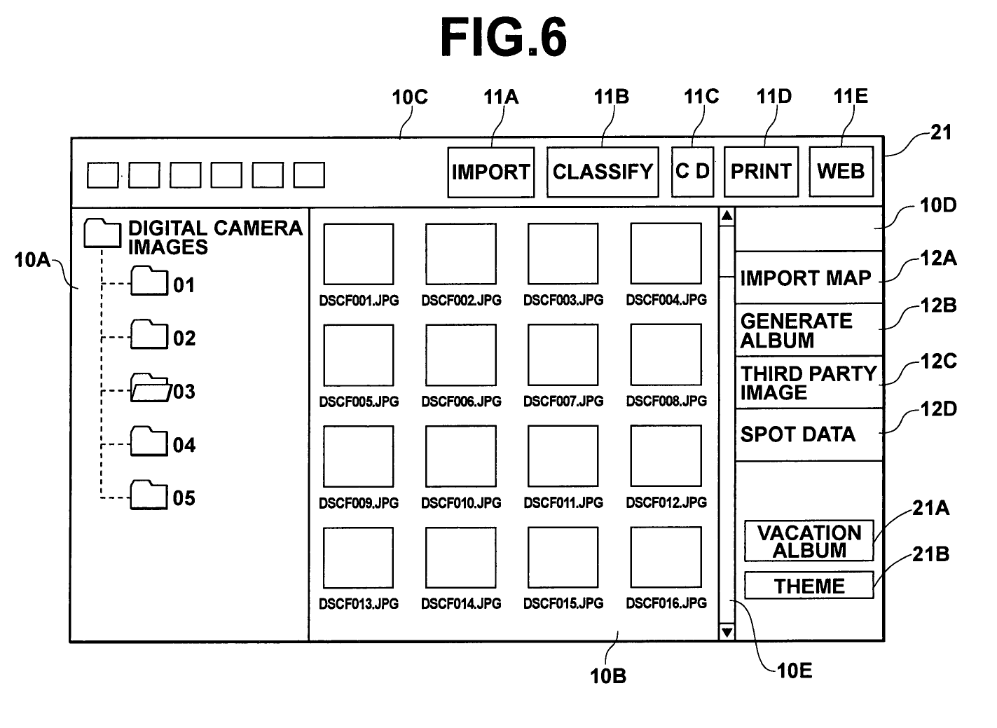

First, an initial screen is displayed at the personal computer 2 (step S1). FIG. 3 is a view of the initial screen of the image management software, displayed at the personal computer 2. As shown in FIG. 6, the initial screen 10 comprises: a folder frame 10A in which folders, which are storage locations of the image data sets S0, are displayed; a thumbnail image frame 10B in which thumbnail images of the image data sets S0, which are stored in a selected folder, are displayed; an operation frame 10C in which various operation buttons are displayed; and a command frame 10D in which various command buttons for inputting commands to the album generation support server 3 are displayed. Note that in the initial screen 10 shown in FIG. 3, a state is shown wherein folder 03, from among digital camera image folders 01 through 05 stored in the personal computer 2, is selected.

File names of the image data sets S0 corresponding to the thumbnail images are displayed along with the thumbnail images of the image data sets S0 stored in the selected folder in the thumbnail image frame 10B. In this state, if a thumbnail image is double clicked by use of a mouse (not shown) of the personal computer 2, the image data set S0 corresponding thereto is enlarged and displayed in a separate window. In addition, if a thumbnail image is single clicked, the thumbnail image can be selected. The selection state is displayed by inverting the display of the thumbnail image, changing the color of the border thereof, or the like. Note that a scroll bar 10E is provided in the thumbnail image frame 10B. In case that the thumbnail images of all of the image data sets S0 stored in the selected folder are not displayed in the thumbnail image frame 10B, the thumbnail image frame 10B can be scrolled by use of the scroll bar 10E. Thereby, the thumbnail images of all of the image data sets S0 stored in the selected folder can be displayed.

Various types of buttons are displayed in the operation frame 10C. However, only the buttons employed in album generation will be described here. An “import” button 11A is clicked when image data sets S0 are to be imported to the personal computer 2 from a memory card inserted in the card reader 2a, or from a digital camera connected to the personal computer 2. A “classify” button 11B is clicked when all of the image data sets S0 stored in the selected folder are to be transmitted to the album generation support server 3, to be classified by the album generation server 33 according to the distances between the photography locations thereof and the user's home. A “CD” button 11C is clicked when an order to record generated album data AL onto a medium M1 is to be placed with the album generation support server 3. A “print” button 11D is clicked when placing an order for printout and binding of generated album data AL with the album generation support server 3. A “web” button 11E is clicked when generated album data AL is to be stored in the album generation support server 3 and displayed as a web page.

An “import map” button 12A, to be clicked when importing a map data set MP to the personal computer 2; a “generate album” button 12B, to be clicked when inputting a command to generate album data AL; a “third party image” button 12C, to be clicked when attaching image data sets photographed by a third party to album data AL, as will be described later; and a “spot data” button 12D, to be clicked when attaching spot data related to a location where an image data set S0 was photographed to album data AL, are displayed in the command frame 10D.

Note that the “import map” button 12A is clicked when a map data set MP is to be obtained with reference to location data attached to an image data set S0, during generation of an album that employs the map data set MP.

The user selects a folder that contains the image data sets S0 for generating album data AL from among the folders displayed in the folder frame 10A of the initial screen 10. Then, thumbnail images of the image data sets S0 stored in the selected folder are displayed in the thumbnail image frame 10B.

In this state, monitoring is initiated to judge whether the “classify” button 11B is clicked (step S2). If the judgment in step S2 is affirmative, the personal computer 2 accesses the album generation support server 3 (step S3). Then, an authentication screen (not shown) that prompts the user to input a user ID and a password is displayed, and a user ID and a password are input (step S4). The web server 32 of the album generation support server 3 judges whether the user has been authenticated (step S5). If the judgment in step S5 is affirmative, access is enabled (step S6), and the following processes are performed. If the judgment in step S5 is negative, access is denied (step S7), and the process ends.

If access is enabled, a web page that represents a transmission screen, for prompting the user to transmit the image data sets S0 stored in the selected folder to the album generation support server 3, is generated by the web server 32 (step S8). The transmission screen is displayed at the user's personal computer 2 (step S9) as a separate window from the initial screen 10.

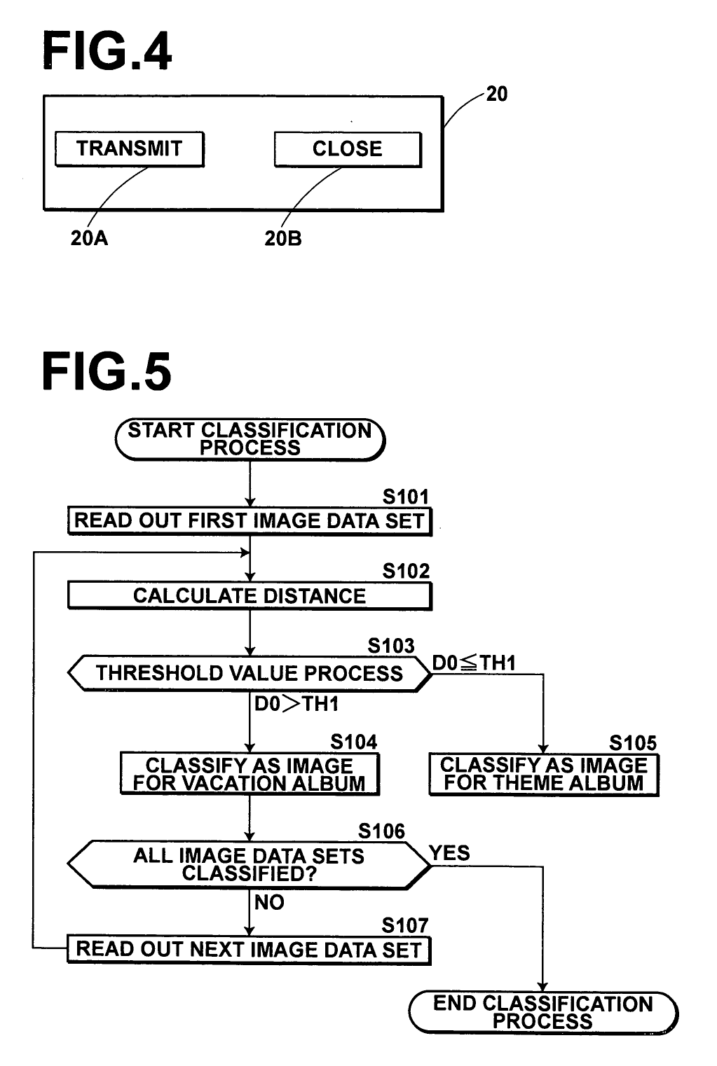

FIG. 4 shows the transmission screen 20. As shown in FIG. 4, a “transmit” button 20A for transmitting the image data sets S0 to the album generation support server 3, and a “close” button 20B for closing the transmission screen 20 without transmitting the image data sets S0 are displayed on the transmission screen 20.

After the transmission screen 20 is displayed, monitoring is initiated to judge whether the “transmit” button 20A is clicked (step S10). If the judgment in step S10 is negative, it is assumed that the “close” button 20B has been clicked, the transmission screen 20 is closed (step S11), and the process returns to step S1.

When the judgment in step S10 is affirmative, the image data sets S0 which are stored in the selected folder are transmitted to the album generation support server 3 (step S12)

The album generation support server 3 receives the image data sets S0 (step S13). The image data sets S0 are stored in the storage means 31 (step S14). Then, the image data sets S0 are classified, based on location data attached thereto, a previously registered reference position, and a predetermined threshold value (step S15).

FIG. 5 is a flow chart showing the classification process. Note that in the present embodiment, the classification process is performed on the image data sets S0 in order, from oldest to newest. First, the date order of the image data sets S0 is determined based on the time data, which represents the date and time of photography, attached thereto. Then, the oldest image data set S0 is designated as the first image data set, and read out from the storage means 31 (step S101). Then, a distance D1 between the photography location of the read out image data set S0 and the user's home, which serves as a reference position, is calculated, based on the location data attached to the read out image data set S0 (step S102). Specifically, the distance D1 is calculated from the location data attached to the image data set S0, that is, the latitude and longitude of the photography location thereof, and the latitude and longitude of the user's home.

Next, a threshold value process, by which the distance D1 is compared against a threshold value TH1, is performed (step S103). Here, a value on the order of 5 km is employed as the threshold value TH1. In the case that the distance D1 exceeds the threshold value TH1, the image data set S0 is assumed to have been photographed at a location remote from the user's home, that is, during a trip, and classified as an image data set for generation of vacation albums (step 104). On the other hand, in the case that the distance D1 is less than or equal to the threshold value TH1, the image data set S0 is assumed to have been photographed in the vicinity of the user's home, and classified as an image data set for generation of albums according to themes, corresponding to events that occur in the vicinity of the user's home (step S105).

Thereafter, it is judged whether classification has been completed for all the transmitted image data sets S0 (step S106) If the judgment in step S106 is negative, the next oldest image data set S0 is readout from the storage means (step S107). Then, the process returns to step S102, and the processes thereafter are performed. If the judgment in step S106 is affirmative, the classification process ends.

When the classification process is complete, a selection screen that prompts the user to select the image data sets S0 classified in either as image data sets for generation of vacation albums or the image data sets for generation of albums according to themes is generated by the web server 32 (step S16). The selection screen is displayed at the personal computer (step S17).

FIG. 6 shows the selection screen 21. As shown in FIG. 6, the selection screen 21 differs from the initial screen 10 in that a “vacation album” button 21A, for selecting the image data sets S0 classified as image data sets for generation of vacation albums, and a “theme” button 21B for selecting the image data sets S0 classified as image data sets for generation of albums according to themes, are displayed at the bottom of the command frame 10D.

Next, monitoring is initiated to judge whether either the “vacation album” button 21A or the “theme” button 21B has been clicked (step S18). If the “vacation album” button 21A is clicked, processes for generating album data AL that represent vacation albums are performed. On the other hand, if the “theme” button 21B is clicked, processes for generating album data AL that represent albums according to themes are performed.

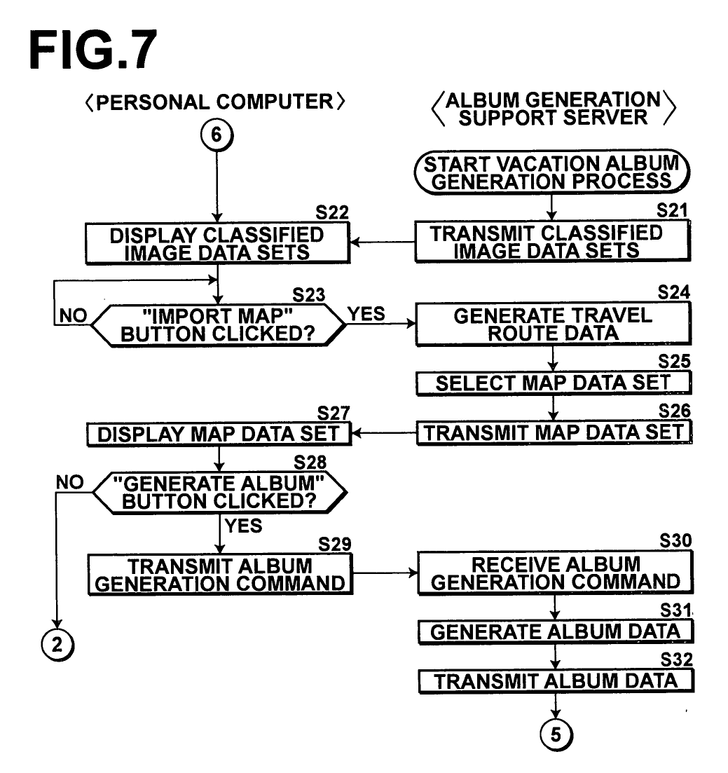

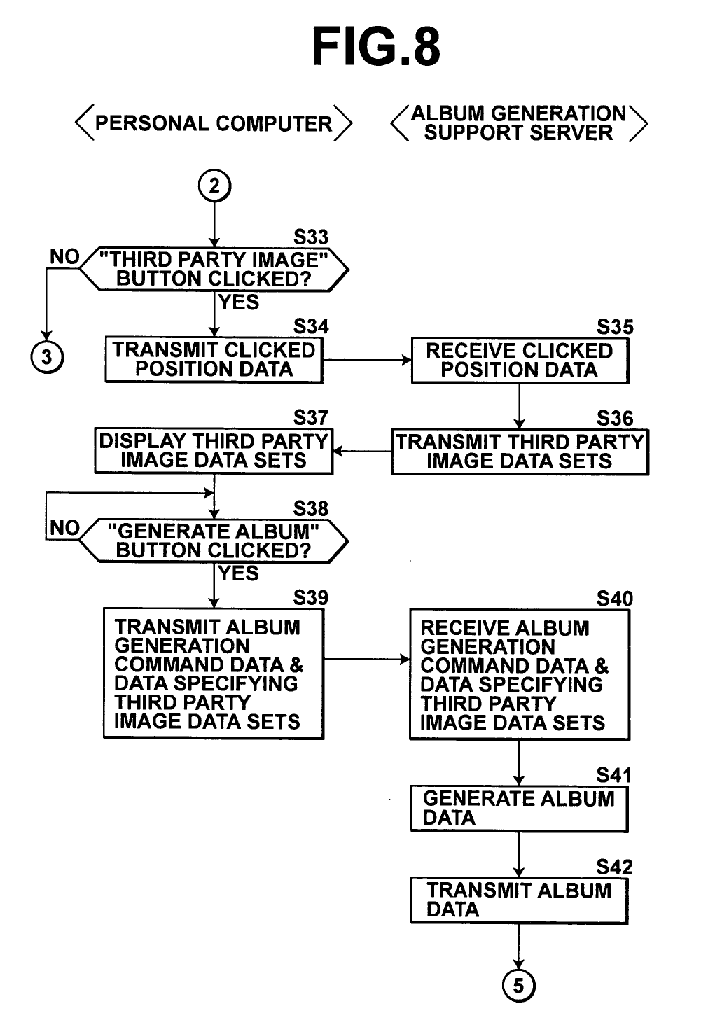

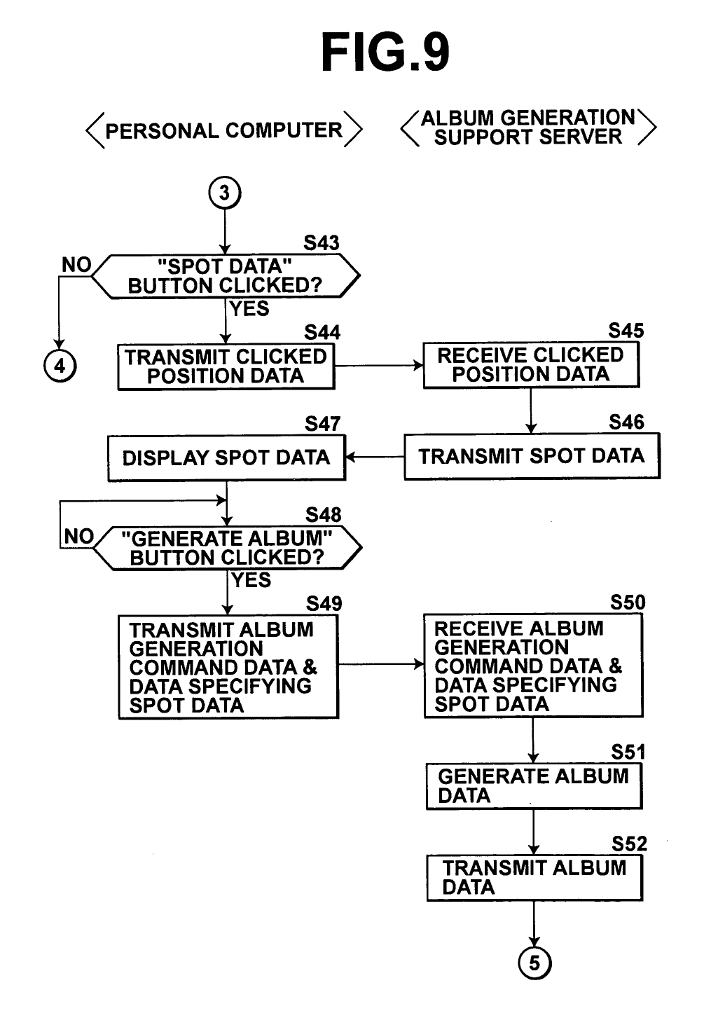

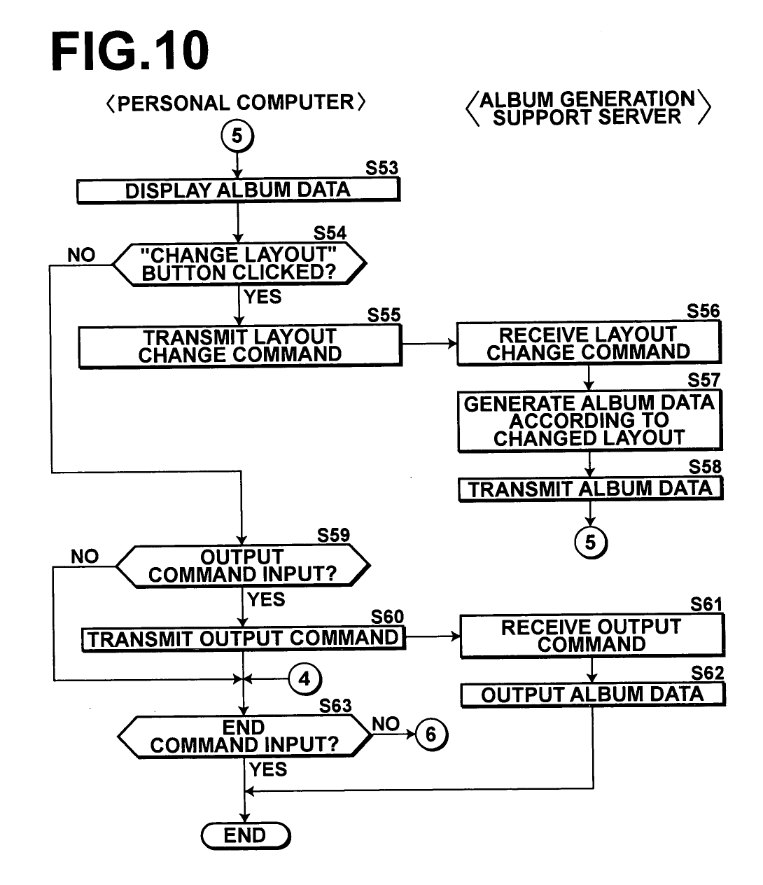

First, the processes which are performed in the case that the “vacation album” button 21A is clicked, and album data AL that represents a vacation album is generated, will be described. FIG. 7 through FIG. 10 are flow charts that show the processes for generating album data AL that represent vacation albums. After the “vacation album” button 21A is clicked, the image data sets S0 which have been classified as image data sets for generation of a vacation album are transmitted to the personal computer 2 (step S21). Note that at this time, the transmitted image data sets S0 need only to be of a size that enables the user to confirm the contents thereof. Therefore, thumbnail images of the image data sets S0 may be transmitted to the personal computer 2 for display thereat.

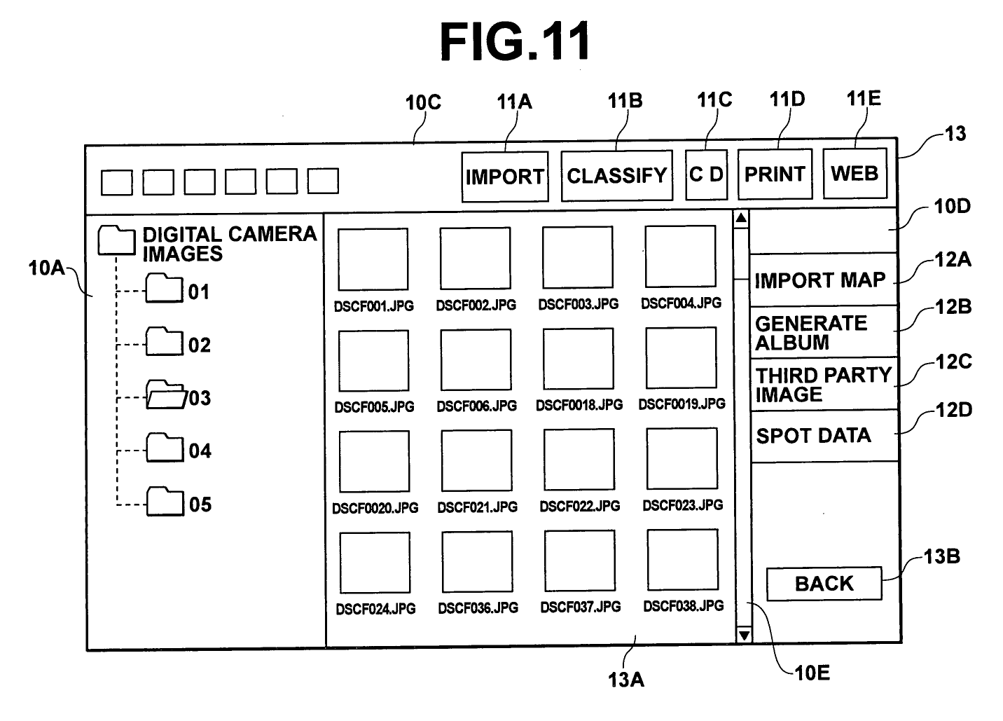

The classified image data sets S0 are displayed at the personal computer 2 (step S22). FIG. 11 shows a classified image display screen 13 for generation of a vacation album. As shown in FIG. 11, the classified image display screen 13 differs from the initial screen 10 in that a classified image thumbnail display frame 13A is displayed instead of the thumbnail image frame 10B, and that a “back” button 13B for returning to the initial screen 10 is displayed at the bottom of the command frame 10D.

Next, monitoring is initiated to judge whether the “import map” button 12A has been clicked (step S23). When the judgment in step S23 is affirmative, the album generation server 33 generates travel route data, based on the location data attached to the classified image data sets S0 (step S24). Specifically, the album generation server 33 detects the route that the user took on a trip, by tracing the location data attached to each of the classified image data sets S0, and generates the travel route data based on the detection results.

After the travel route data is generated in this manner, a map data set MP that includes the travel route represented by the generated travel route data is selected from the map data base DB1, which is stored in the storage means 31 (step S25). At this time, user data of the user who is accessing the album generation support server 3 may be referenced, to select a map data set MP that reflects the preferences of the user.

A map data set MP of a scale that maximally displays the user's travel route is selected. Note that a region that maximally displays the user's travel route may be cut out from map data which is stored in the storage means 31, and employed as the map data set MP, as necessary. In addition, map data sets MP of different time periods are stored in the storage means 31. Therefore, a map data set MP corresponding to the time period during which the image data sets S0 were photographed is selected, based on the time data attached to the image data sets S0.

The selected map data MP is transmitted to the personal computer 2 (step S26), and displayed at the personal computer 2 (step S27).

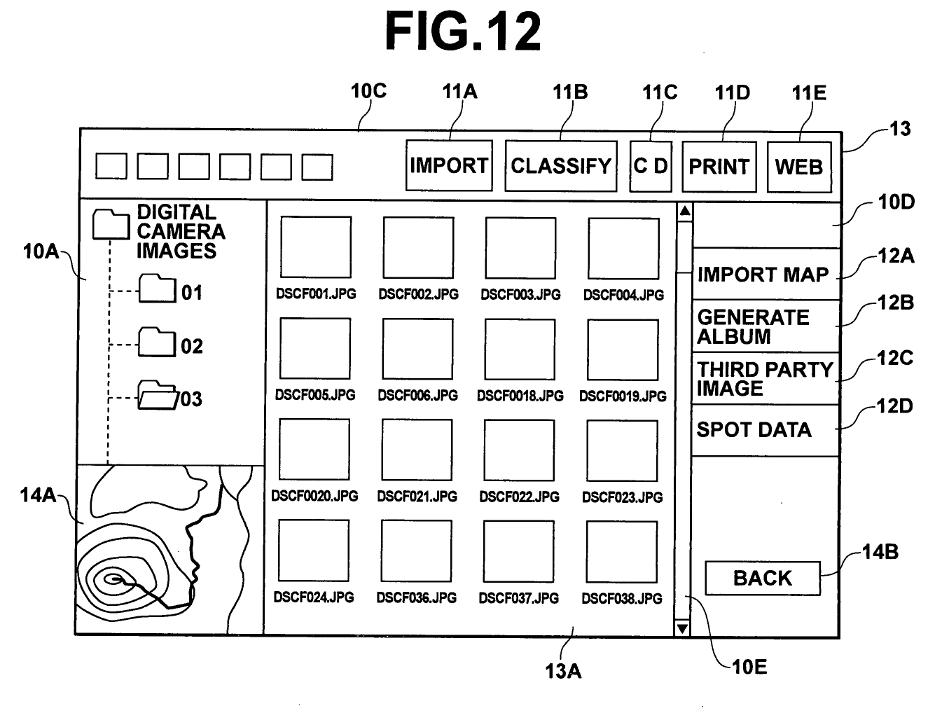

FIG. 12 shows a map display screen 14. As shown in FIG. 12, the map display screen 14 differs from the classified image display screen 13 in that a map frame 14A is provided beneath the folder frame 10A, and a “back” button 14B is displayed at the bottom of the command frame 10D. The map data set MP which has been transmitted from the album generation support server 3 is displayed in the map frame 14A. Note that the travel route is indicated by, for example, a bold line on the map displayed in the map frame 14A. Thereby, the user can confirm the map data set MP which is to be utilized in the generation of album data AL.

The user selects image data sets S0 to be included in the album data AL. Then, monitoring is initiated to judge whether the “generate album” button 12B is clicked (step S28). If the judgment in step S28 is affirmative, album generation command data, for instructing the album generation support server 3 to generate album data AL, is transmitted to the album generation support server 3 (step S29).

The album generation command data is received at the album generation support server 3 (step S30). The album generation server 33 generates album data AL based on the image data sets S0 and the map data set MP (step S31). Specifically, the album data AL is generated by arranging the image data sets S0 and the map data set MP on a predetermined template.

Note that because time data, representing the date and time of photography, is attached to the image data sets S0, a map data set MP may be selected for each date, and the album data AL may be generated with the image data sets S0 organized by the date of photography.

The generated album data AL is transmitted to the personal computer 2 as a web page (step S32).

On the other hand, if the judgment in step S28 is negative, it is judged whether the user has clicked a desired position on the map, then clicked the “third party image” button 12C (step S33). If the judgment in step S33 is affirmative, data regarding the position clicked on the map (referred to as “clicked position data”) is transmitted to the album generation support server 3 (step S34).

The clicked position data is received at the album generation support server 3 (step S35). Third party image sets corresponding to the position clicked on the map are read out from the storage means 31 and transmitted to the personal computer 2 (step S25). Note that at this time, the transmitted third party image sets need only to be of a size that enables the user to confirm the contents thereof. Therefore, thumbnail images of the third party image data sets may be transmitted to the personal computer 2 for display thereat, as will be described later.

Note that a desired region on the map may be selected, the data regarding the selected region transmitted to the album generation support server 3, and third party image data sets corresponding to the selected region read out from the storage means 31 to be transmitted to the personal computer 2. The selection of the region may be performed by a click and drag operation of a mouse, or by clicking a central position, then specifying a radius therearound.

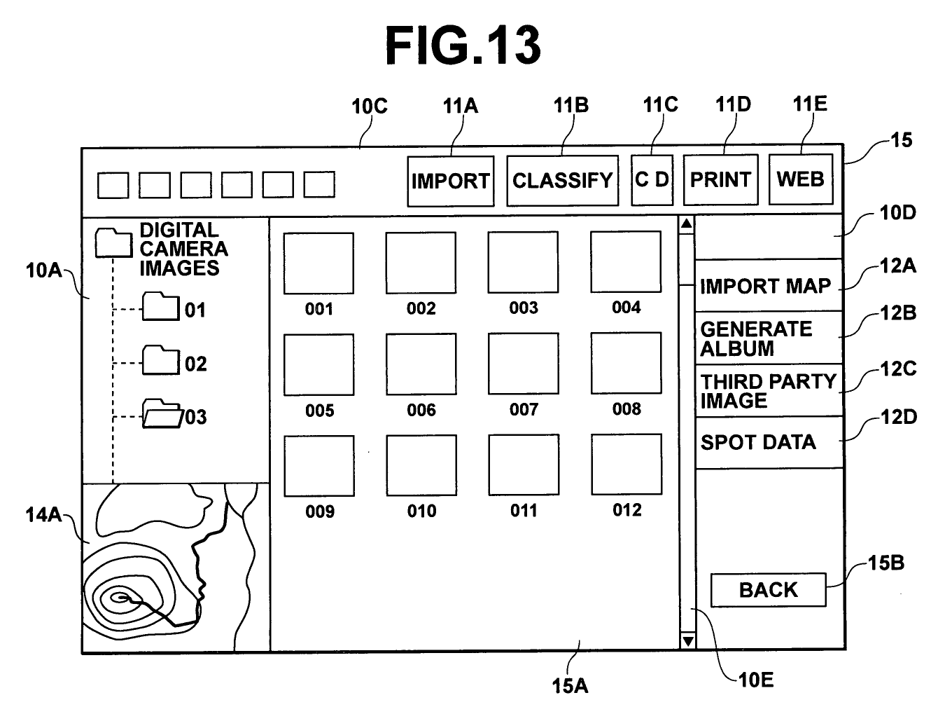

The third party image data sets are displayed at the personal computer 2 (step S37). FIG. 13 shows a third party image display screen 15. As shown in FIG. 13, the third party image display screen 15 differs from the map display screen 14 in that a third party image thumbnail display frame 15A is displayed instead of the classified image thumbnail display frame 13A, and that a “back” button 15B for returning to the map display screen 14 is displayed at the bottom of the command frame 10D.

Third party image data sets that the user desires to include in the album may be selected by clicking the thumbnail images of the third party image data sets at the third party image display screen 15. At this time, a plurality of third party image data sets may be selected. Then, monitoring is initiated to judge whether the “generate album” button 12B has been clicked (step S38). If the judgment is step S38 is affirmative, data specifying the selected third party image data sets (for example, the file names of the selected third party image data sets) is transmitted to the album generation support server, along with the album generation command data (step S39). Note that the user may return to the map display screen 14 without selecting any third party image data sets, by clicking on the “back” button 15B.

The album generation support server 3 receives the album generation command data and the data specifying the selected third party image data sets (step S40). The album generation server 33 reads out the third party image data sets selected by the user from the storage means 31 then generates album data AL based on the image data sets S0, the third party image data sets, and the map data set MP (step S41). The generated album data AL is transmitted to the personal computer 2 as a web page (step S42).

On the other hand, if the judgment in step S33 is negative, it is judged whether the user has clicked a desired position on the map, then clicked the “spot data” button 12D (step S43). If the judgment in step S43 is affirmative, data regarding the position clicked on the map (referred to as “clicked position data”) is transmitted to the album generation support server 3 (step S44).

The clicked position data is received at the album generation support server 3 (step S45). Spot data corresponding to the position clicked on the map are read out from the storage means 31 and transmitted to the personal computer 2 (step S46).

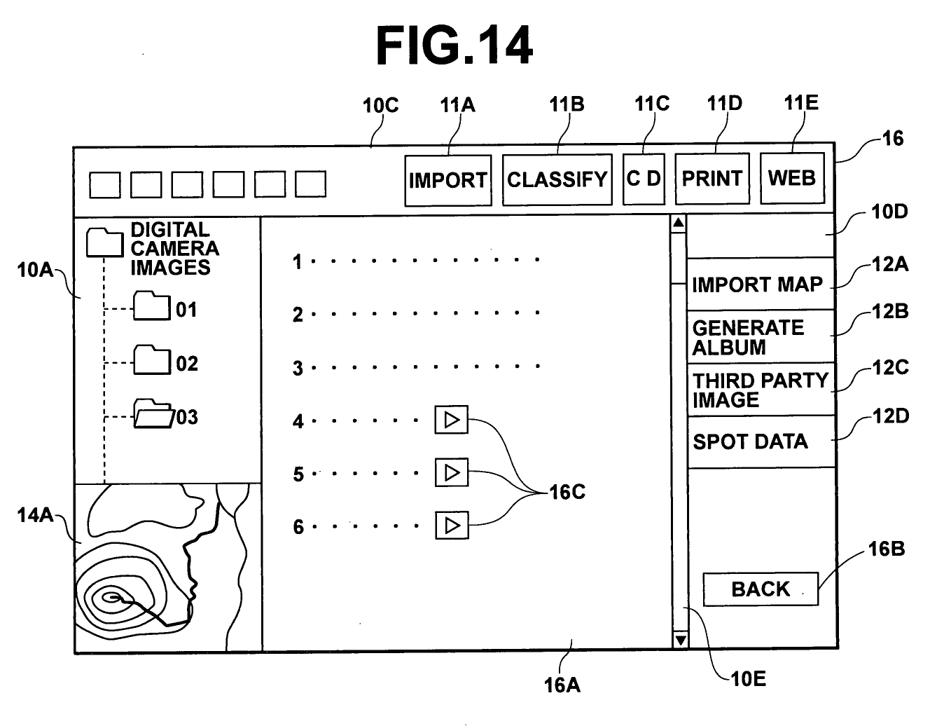

The spot data is displayed at the personal computer 2 (step S47). FIG. 14 shows a spot data display screen 16. As shown in FIG. 14, the spot data display screen 16 differs from the map display screen 14 in that a spot data display frame 16A is displayed instead of the classified image thumbnail display frame 13A, and that a “back” button 16B for returning to the map display screen 14 is displayed at the bottom of the command frame 10D. A plurality of spot data sets, each labeled with a number, is displayed in the spot data display frame 16A.

In the case that the spot data set is audio data, a “play” button 16C is displayed along with the number and a description of the spot data set. The user may reproduce the audio data by clicking the “play” button 16C.

Spot data sets that the user desires to include in the album may be selected by clicking the numbers of the spot data sets at the spot data display screen 16. At this time, a plurality of spot data sets may be selected. Then, monitoring is initiated to judge whether the “generate album” button 12B has been clicked (step S48). If the judgment is step S48 is affirmative, data specifying the selected spot data sets (for example, the numbers of the spot data sets) is transmitted to the album generation support server, along with the album generation command data (step S49). Note that the user may return to the map display screen 14 without selecting any spot data sets, by clicking on the “back” button 16B.

The album generation support server 3 receives the album generation command data and the data specifying the selected spot data sets (step S50). The album generation server 33 reads out the spot data sets selected by the user from the storage means 31 then generates album data AL based on the image data sets S0, the spot data sets, and the map data set MP (step S51). The generated album data AL is transmitted to the personal computer 2 as a web page (step S52).

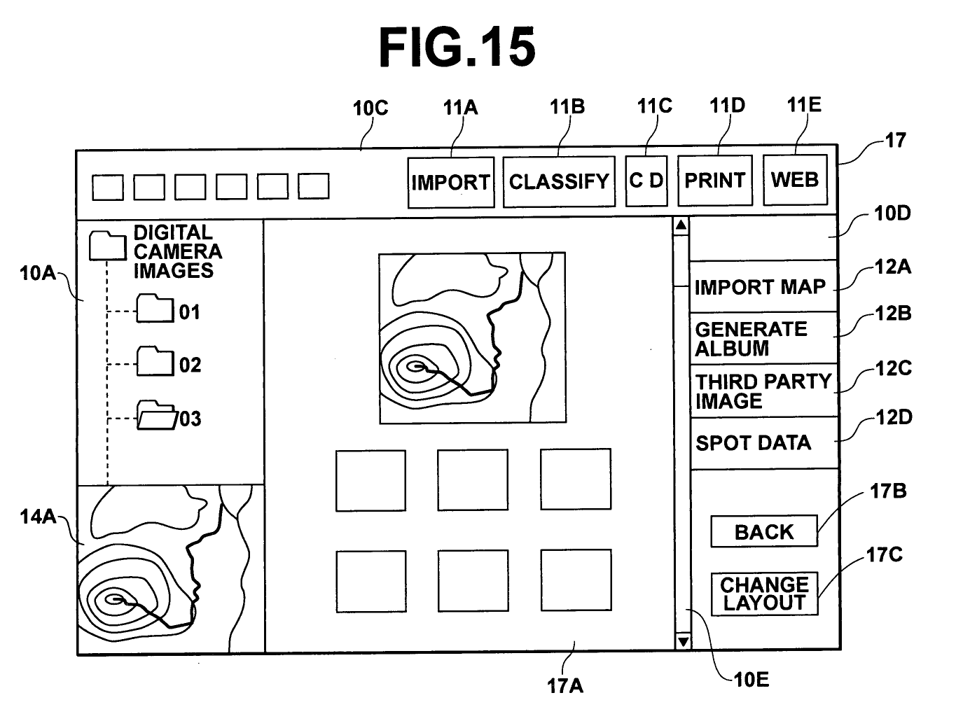

The album data AL, which has been transmitted to the personal computer 2 is displayed in an album display screen (step S53). FIG. 15 shows the album display screen 17. As shown in FIG. 15, the album display screen 17 differs from the map display screen 14 in that an album display frame 17A, in which an album represented by the album data AL is displayed, is displayed instead of the classified image thumbnail display frame 13A, and that a “back” button 17B for returning to the map display screen 14 as well as a “change layout” button 17C for changing the layout of the album are displayed at the bottom of the command frame 10D.

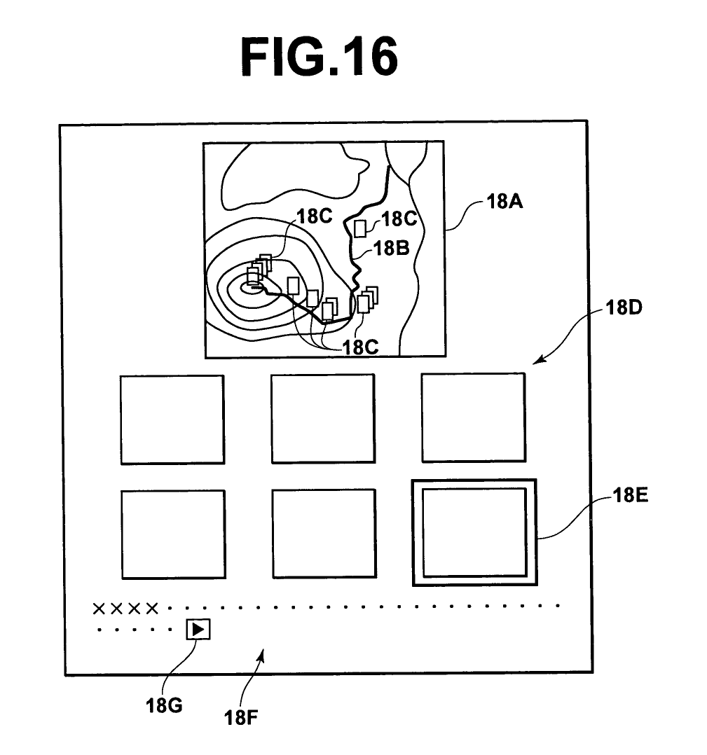

FIG. 16 shows the detailed layout of the album displayed in the album display frame 17A. As shown in FIG. 16, in the album displayed in the album display frame 17A, a travel route 18B of the user is indicated by a bold line on a map 18A, and icons 18C that represent photography locations of the image data sets S0 are attached along the travel route 18B. Note that one type of icon 18c is attached at positions on the map to which a single image data set S0 is correlated, and another type of icon 18c is attached at positions on the map to which a plurality of image data sets S0 are correlated.

Note that as the user generally travels along the travel route 18B in both the outward and homeward directions, the color of the travel route 18B displayed on the map 18A, as well as that of the icons 18C attached may be different for the outward leg and the homeward leg of the trip.

The correlation between the positions on the travel route 18B and the image data sets S0 is performed by: calculating the user's travel speed based on a departure date and time, an arrival date and time, and the distance of the travel route 18B; calculating the distance traveled from the departure point at a date and time of photography, based on the user's travel speed and the time data attached to the image data set S0; and setting a point on the travel route 18B at the calculated distance from the departure point as the position at which the image data set S0 was photographed.

When the user clicks on an icon 18C on the map 18A, thumbnail images 18D of the image data sets S0 correlated with the position of the clicked icon 18C are displayed below the map 18A. Note that in the case that the user has input commands to include third party image data sets or spot data in the album data AL, thumbnail images 18E of the third party image data sets and spot data 18F are displayed along with the thumbnail images 18D. In the case that the spot data is audio data, a “play” button 18G is displayed. In order to distinguish the thumbnail images 18E of the third party image data sets from the image data sets S0, which have been photographed by the user, the borders of the thumbnail images 18E are of a different color than that of the thumbnail images 18D of the image data sets S0. When a different icon 18C on the map 18A is clicked, the display of the thumbnail images 18D is switched to that of the image data sets S0, the third party image data sets, and the spot data correlated with the position of the newly clicked icon 18C.

The user may return to the map display screen 14, the third party image display screen 15, or the spot data display screen 16 without performing processes such as output of the album data AL, by clicking the “back” button 17B.

Meanwhile, it is judged whether the “change layout” button 17C has been clicked (step S54). If the judgment in step S54 is affirmative, a layout change command is transmitted to the album generation support server 3 (step S55).

The album generation support server 3 receives the layout change command (step S56), and album data AL is generated based on a new layout (step S57). That is, album data AL of a different layout than that shown in FIG. 12 is generated, by changing the template on which the image data sets S0, the map data set MP, the third party image data sets and/or the spot data are arranged.

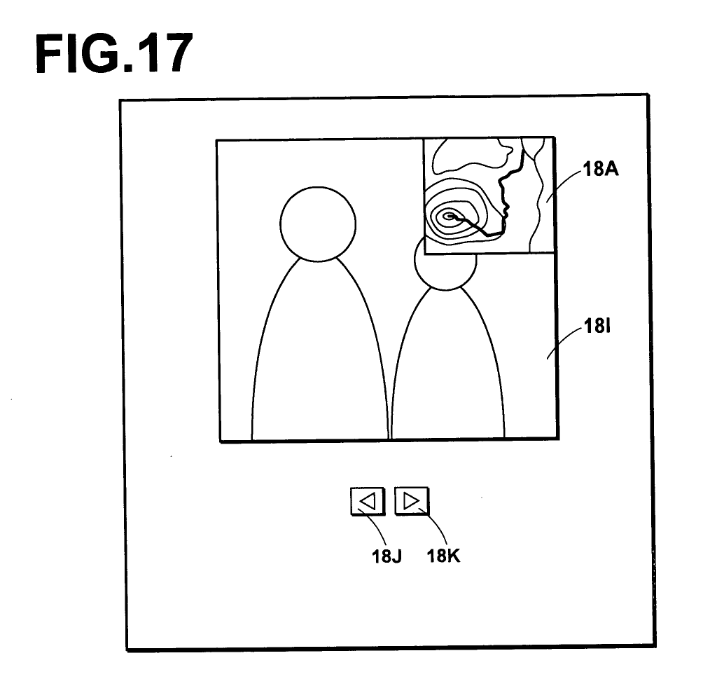

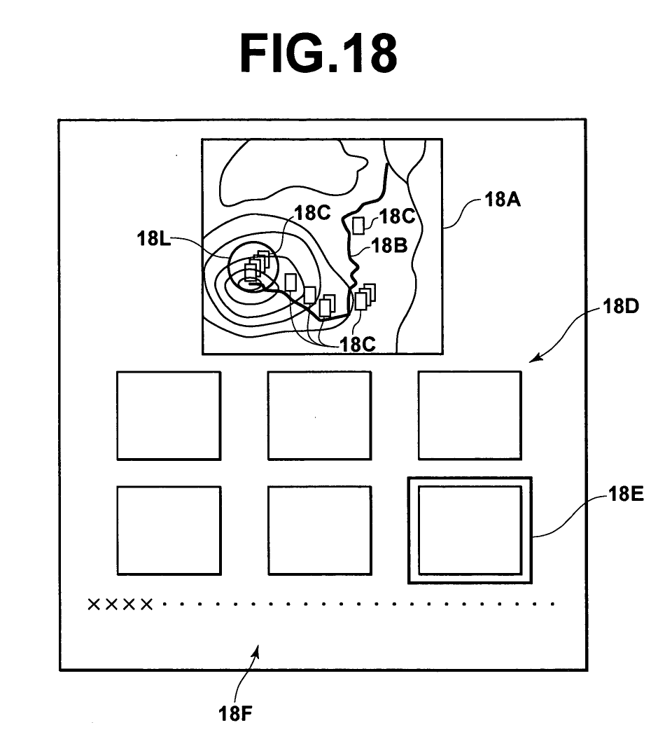

For example, album data AL representing an album having the layout shown in FIG. 17 is generated. In the layout shown in FIG. 17, the map 18A is displayed at a portion of a single image 18I. Images corresponding to different positions on the map 18A are displayed by switching the specified position on the map 18A by clicking arrow buttons 18J and 18K.

The regenerated album data AL is transmitted to the personal computer 2 (step S58). The process returns to step S53, and the processes thereafter are performed.

If the judgment in step S54 is negative, it is judged whether an output command has been input for the album data AL, by the user clicking one of the “CD” button 11C, the “print” button 11D, or the “web” button 11E (step S59). If the judgment in step S59 is affirmative, an output command is transmitted to the album generation support server 3 (step S60).

The album generation support server 3 receives the output command (step S61), and the album data AL is output according to the output command (step S62). That is, in the case that the “CD” button 11C was clicked, the album data AL is recorded onto a medium M1 by the media drive 34. In the case that the “print” button 11D was clicked, the album data AL is printed by the printer 35, and bound. In the case that the “web” button 11E was clicked, the album data AL is stored in the storage means 31, and provided for viewing over the network 1.

Note that in the case that the album data AL is output by printing, a page is printed for image data sets S0 corresponding to each photography location on the map 18A. In addition, regarding a single page, icons 18C are specified on the map 18A by being enclosed in a circle 18L or the like. The image data sets S0 which have been photographed at the photography locations indicated by the specified icons are displayed on the page. Note that as prints cannot reproduce audio data, the “play” button shown in FIG. 16 is not displayed on the prints.

The personal computer 2 judges whether an end command has been input (step S63), and if the judgment in step S63 is affirmative, the process is ended. If the judgment in step S63 is negative, the process returns to step S22. Note that in the case that the judgment in step S43 or step S59 is negative, the process proceeds to step S63, and it is judged whether an end command has been input.

Note that it is possible for the printing to be performed by the user's printer, connected to the personal computer 2.

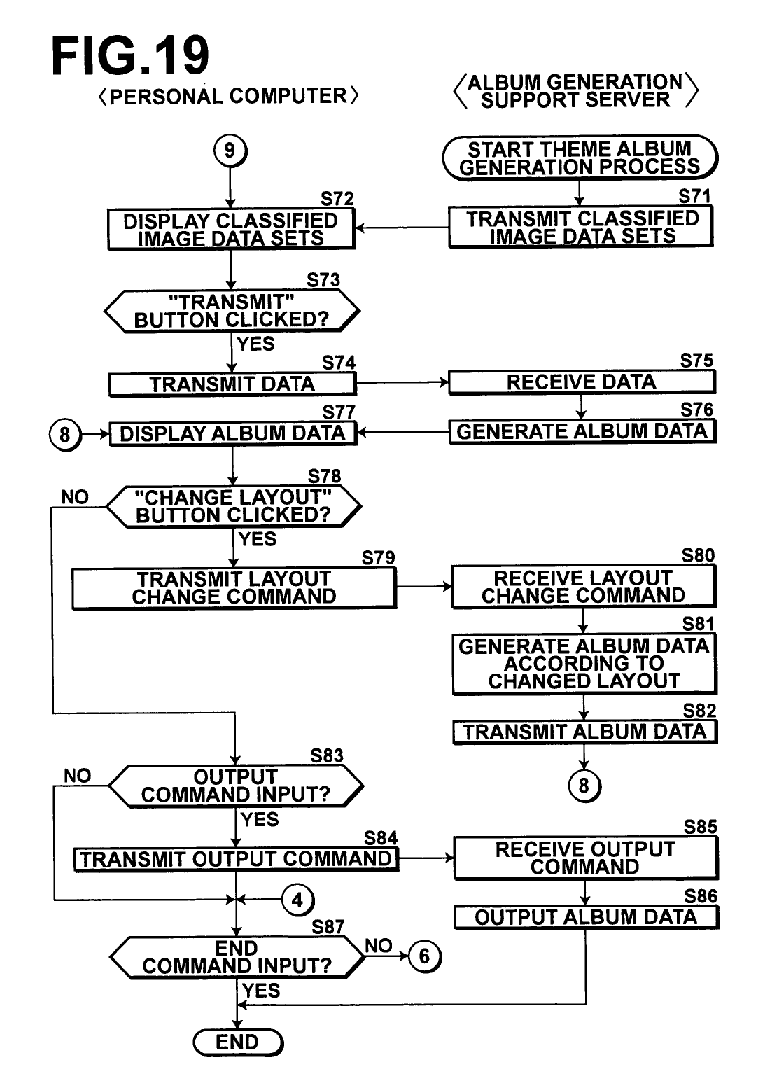

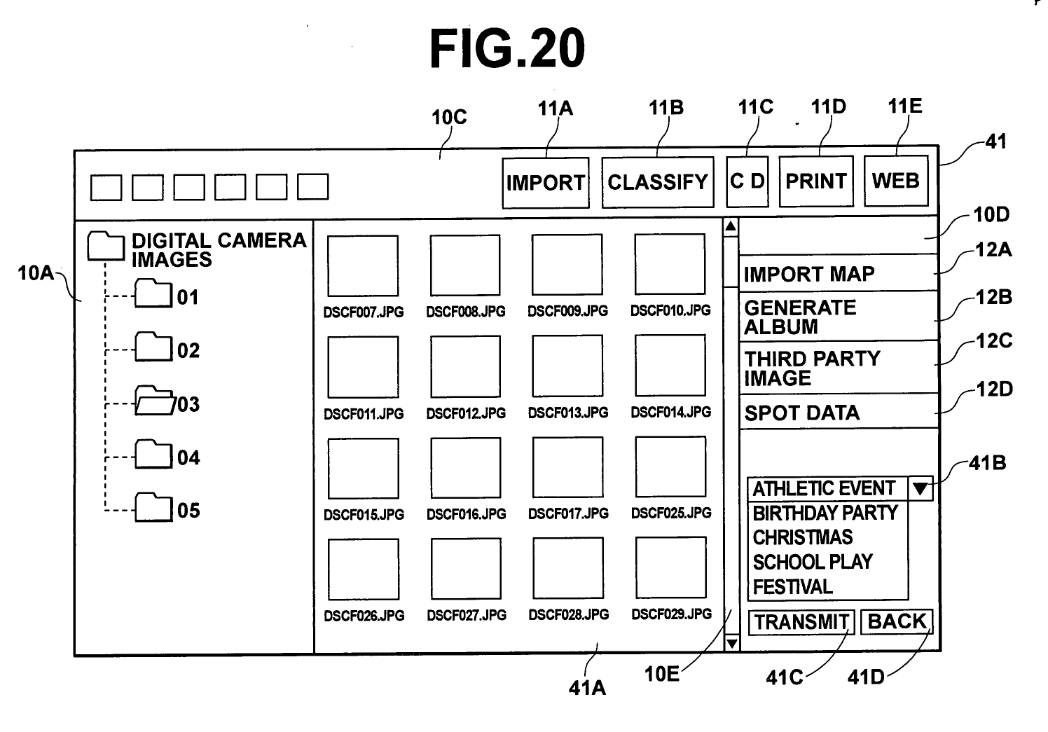

Next, the processes which are performed in the case that the “theme” button 21B is clicked, and album data AL that represents an album according to a theme is generated, will be described. FIG. 19 is a flow chart that shows the processes for generating album data AL that represents an album according to a theme. After the “theme” button is clicked, the image data sets S0, which have been classified as image data sets for an album according to a theme, are transmitted to the personal computer 2 (step S71). The classified image data sets S0 are displayed at the personal computer 2 (step S72). FIG. 20 shows a classified image display screen for generation of an album according to a theme. As shown in FIG. 20, the classified image display screen 41 differs from the initial screen 10 in that a classified image thumbnail display frame 41A is displayed instead of the thumbnail image frame 10B, and that a pull down menu 41B for selecting a theme for the album, a “transmit” button 41C for transmitting data representing the selected theme, and a “back” button 41D for returning to the initial screen 10 are displayed at the bottom of the command frame 10D.

The pull down menu 41B enables selection of album themes such as “athletic event”, “birthday party”, “Christmas”, “school play”, and “festival”. The user selects image data sets S0 to generate the album for, as well as a theme. Then, monitoring is initiated to judge whether the “transmit” button 41C has been clicked (step S73). When the judgment in step S73 is affirmative, the selected image data sets S0, as well as the data representing the selected theme (hereinafter, referred to simply as “theme data”), are transmitted to the album generation support server 3 (step S74).

The album generation support server 3 receives the selected image data sets S0 and the selected theme data (step S75), and album data AL according to the theme is generated (step S76) Specifically, the album data AL is generated by reading out a template, which has a design corresponding to the theme, from the storage means 31, then arranging the image data sets S0 on the read out template.

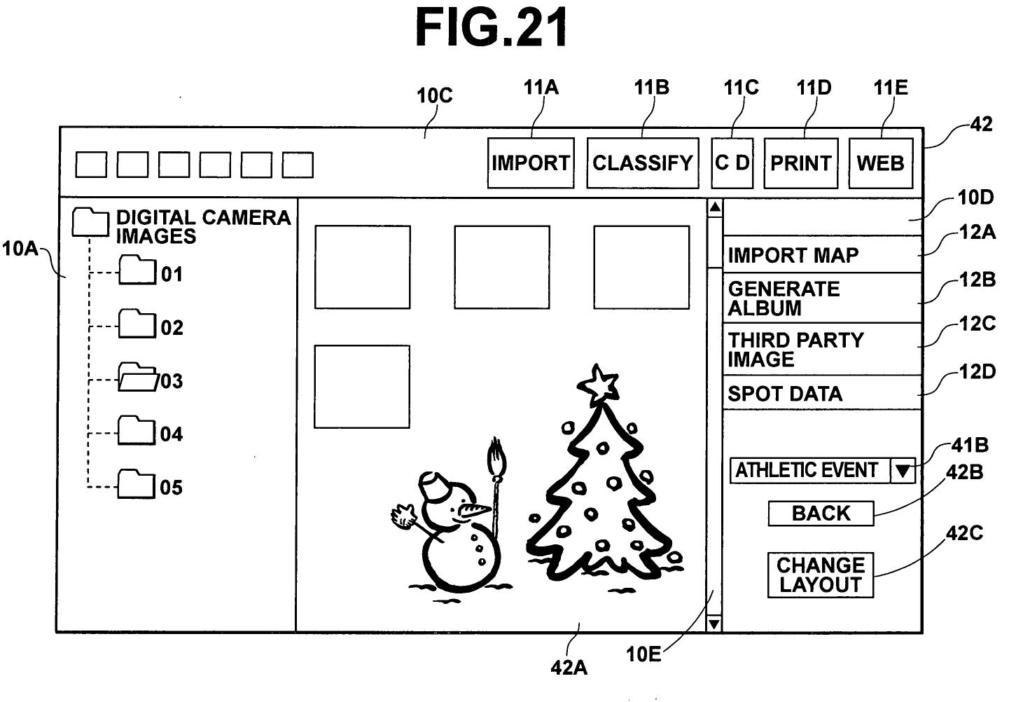

The album data AL is transmitted to the personal computer 2 and displayed on an album display screen (step S77). FIG. 21 shows an album display screen 42. As shown in FIG. 21, the album display screen 42 differs from the classified image display screen 41 in that an album display frame 42A, in which an album represented by the album data AL is displayed, is displayed instead of the classified image thumbnail display frame 41A, and that a “back” button 42B for returning to the classified image display screen 41 as well as a “change layout” button 42C for changing the layout of the album are displayed at the bottom of the command frame 10D. Note that in FIG. 21, album data AL in the case that “Christmas” has been selected as the theme is displayed in the album display frame 42A.

The user may return to the classified image display screen 41 from the album display screen 42, without performing processes such as output of the album data AL, by clicking the “back” button 42B.

Meanwhile, monitoring is initiated to judge whether the “change layout” button 42C has been clicked (step S78) If the judgment in step S78 is affirmative, a layout change command is transmitted to the album generation support server 3 (step S79)

The album generation support server 3 receives the layout change command (step S80), and album data AL is generated based on a new layout (step S81).

The regenerated album data AL is transmitted to the personal computer 2 (step S82). The process returns to step S77, and the processes thereafter are performed.

If the judgment in step S78 is negative, it is judged whether an output command for the album data AL has been input by the user clicking one of the “CD” button 11C, the “print” button 11D or the “web” button 11E (step S83). If the judgment in step S83 is affirmative, an output command is transmitted to the album generation support server 3 (step S84).

The album generation support server 3 receives the output command (step S85), and the album data AL is output according to the output command (step S86).

The personal computer 2 judges whether an end command has been input (step S87), and if the judgment in step S87 is affirmative, the process is ended. If the judgment in step S87 is negative, the process returns to step S72. Note that in the case that the judgment in step S83 is negative, the process proceeds to step S87, and it is judged whether an end command has been input. Note that it is possible for the printing to be performed by the user's printer, connected to the personal computer 2.

As described above, the present embodiment calculates a distance D1 between a photography location of an image data set S0 and a predetermined reference position, such as the user's home, based on the location data attached to the image data set S0. Then, a judgment is made as to whether the calculated distance D1 exceeds a predetermined threshold value TH1, and the image data set S0 is classified based on the judgment. Album data AL representing a vacation album or an album according to a theme is generated according to the classification result. Therefore, image data sets S0 can be efficiently classified according to the distances between the photography locations thereof and the predetermined reference position, even if a memory card of a digital camera has a high capacity, and a great number of image data sets S0 are recorded therein. As a result, generation of album data AL is facilitated.

In addition, the present embodiment obtains travel route data, which includes the user's travel route based on the location data attached to the image data sets S0. A map data set MP is selected from the map database DB1 based on the obtained travel route data. Then, album data AL is generated, in which locations along the travel route 18B on the map 18A, represented by the map data set MP, are correlated with the photography locations of the image data sets S0.

Therefore, the image data sets S0 are easily correlated to the photography locations thereof, along the travel route 18B on the map 18A. Accordingly, the image data sets S0 and the photography locations are easily correlated, thereby enabling easy generation of album data AL representing a vacation album.

In addition, data related to the photography location of an image data set, such as third party image data sets and spot data maybe obtained, and the album data may be generated having the related data correlated to the map data set. Thereby, data related to the photography location of the image data set may also be included in the album data AL, in addition to the image data sets S0. Accordingly, the contents of the album can be enriched.

During generation of album data AL representing an album according to a theme, the album data AL is generated according to a selected theme. Therefore, an album can be generated according to an event or the like which has a high probability of occurrence at the user's home or the vicinity thereof.

In addition, in the embodiment described above, if the “third party image” button 12C is clicked, third party image data sets corresponding to the position clicked on the map are transmitted to the personal computer 2, to be included in the album data AL. However, video data correlated to the clicked location may be employed as the third party image data sets, instead of the image data sets.

Further, in the embodiment described above, the map data set MP is selected based on the travel route data and the user data. However, it is preferable that the album generation 33 has a learning function to learn the selection pattern of map data sets MP for each user, to gradually reduce the number of candidates of map data sets MP to be selected according to the user. Thereby, efficient selection of map data sets MP for each user is enabled.

Still further, in the embodiment described above, the personal computer 2 accesses the album generation support server 3, and the album data AL is generated by the album generation support server 3. However, the data stored in the storage means 31 may be stored in the personal computer 2, and software may be installed in the personal computer that enables performance of the processes performed by the album generation server 33. Thereby, the user is enabled to generate the album data AL without accessing the album generation support server 3, by employing the personal computer 2.

The method of album generation of the present invention may be provided as a program that causes a computer to execute the method. The program may be recorded on a computer readable medium. A skilled artisan would know that the computer readable medium is not limited to any specific type of storage device, and includes any kind of device, including but not limited to CD's, floppy disks, RAM's, ROM's, hard disks, magnetic tapes and internet downloads, in which computer instructions can be stored and/or transmitted. Transmission of computer code through a network or through wireless transmission means is also within the scope of the present invention. Additionally, computer code/instructions include, but are not limited to, source, object, and executable code and can be in any language including but not limited to higher level languages, assembly language and machine language.

What is claimed is:

1. A method for generating an album based on album data including at least one image data set, which has been photographed during a trip and which has location data representing a photography location attached thereto, comprising the steps of:
calculating a distance between the photography location of the image data set and a predetermined reference position, based on the location data;
judging whether the distance is over a predetermined threshold value;
classifying the image data set according to the result of judgment; and
generating the album data according to the result of classification.

2. A method for generating an album as defined in claim 1, further comprising the steps of:
generating travel route data, which represents a route taken during the trip, based on the location data attached to the at least one image data set for which the distance is over the predetermined threshold value;
obtaining a map data set that contains the route from a map database which stores a plurality of map data sets, based on the travel route data;
generating photography data which represents that the image data set was obtained at the photography location along the route;
attaching the photography data to the map data set; and
generating album data including the map data set, in which the photography data is correlated with the image data set.

3. A method for generating an album as defined in claim 1, further comprising the steps of:
obtaining related data, which is related to the photography location of the at least one image data set for which the distance is over the predetermined threshold value, based on the location data attached thereto, from a related data storage means which stores a plurality of related data sets; and
generating album data, which includes the related data.

4. A method for generating an album as defined in claim 1, further comprising the steps of:
obtaining related data, which is related to the photography location of the at least one image data set for which the distance is over the predetermined threshold value, based on the location data attached thereto, from a related data storage means which stores a plurality of related data sets; and
generating album data, which includes the related data.

5. A method for generating an album as defined in claim 1, wherein:
album data is generated according to predetermined themes, for the at least one image data set for which the distance is less than or equal to the predetermined threshold value.

6. An album generating apparatus that generates album data including at least one image data set, which has been photographed during a trip and which has location data representing a photography location attached thereto, comprising:
a distance calculating means for calculating a distance between the photography location of the image data set and a predetermined reference position, based on the location data;
judgment means for judging whether the distance is over a predetermined threshold value;
classification means for classifying the image data set according to the result of judgment; and
album data generating means for generating the album data according to the result of classification.

7. An album generating apparatus as defined in claim 6, further comprising:
travel route data generating means for generating travel route data, which represents a route taken during the trip, based on the location data attached to the at least one image data set for which the distance is over the predetermined threshold value;
map data set obtaining means for obtaining a map data set that contains the route from a map database which stores a plurality of map data sets, based on the travel route data;
photography data generating means for generating photography data which represents that the image data set was obtained at the photography location along the route; and
photography data attaching means for attaching the photography data to the map data set; wherein
the album data generating means generates album data including the map data set, in which the photography data is correlated with the image data set.

8. An album generating apparatus as defined in claim 6, further comprising:
related data obtaining means for obtaining related data, which is related to the photography location of the at least one image data set for which the distance is over the predetermined threshold value, based on the location data attached thereto, from a related data storage means which stores a plurality of related data sets; wherein
the album data generating means generates album data, which includes the related data.

9. An album generating apparatus as defined in claim 7, further comprising:
related data obtaining means for obtaining related data, which is related to the photography location of the at least one image data set for which the distance is over the predetermined threshold value, based on the location data attached thereto, from a related data storage means which stores a plurality of related data sets; wherein
the album data generating means generates album data, which includes the related data.

10. An album generating apparatus as defined in claim 6, wherein:
the album data generating means generates album data according to predetermined themes, for the at least one image data set for which the distance is less than or equal to the predetermined threshold value.

11. A program that causes a computer to execute a method for generating an album based on album data including at least one image data set, which has been photographed during a trip and which has location data representing a photography location attached thereto, the program comprising the procedures of:
calculating a distance between the photography location of the image data set and a predetermined reference position, based on the location data;
judging whether the distance is over a predetermined threshold value;
classifying the image data set according to the result of judgment; and
generating the album data according to the result of classification.

12. A program as defined in claim 11, further comprising the procedures of:
generating travel route data, which represents a route taken during the trip, based on the location data attached to the at least one image data set for which the distance is over the predetermined threshold value;
obtaining a map data set that contains the route from a map database which stores a plurality of map data sets, based on the travel route data;
generating photography data which represents that the image data set was obtained at the photography location along the route; and
attaching the photography data to the map data set; wherein
the procedure of generating album data generates album data including the map data set, in which the photography data is correlated with the image data set.

13. A program as defined in claim 11, further comprising the procedure of:
obtaining related data, which is related to the photography location of the at least one image data set for which the distance is over the predetermined threshold value, based on the location data attached thereto, from a related data storage means which stores a plurality of related data sets; wherein
the procedure of generating album data generates album data, which includes the related data.

14. A program as defined in claim 12, further comprising the procedure of:
obtaining related data, which is related to the photography location of the at least one image data set for which the distance is over the predetermined threshold value, based on the location data attached thereto, from a related data storage means which stores a plurality of related data sets; wherein
the procedure of generating album data generates album data, which includes the related data.

15. A program as defined in claim 11, wherein:
the procedure of generating album data generates album data according to predetermined themes, for the at least one image data set for which the distance is less than or equal to the predetermined threshold value.

16. A computer readable medium storing thereon a program that causes a computer to execute a method for generating an album based on album data including at least one image data set, which has been photographed during a trip and which has location data representing a photography location attached thereto, the program comprising the procedures of:
calculating a distance between the photography location of the image data set and a predetermined reference position, based on the location data;
judging whether the distance is over a predetermined threshold value;
classifying the image data set according to the result of judgment; and
generating the album data according to the result of classification.

17. A recording medium as defined in claim 16, wherein the program further comprises the procedures of:
generating travel route data, which represents a route taken during the trip, based on the location data attached to the at least one image data set for which the distance is over the predetermined threshold value;
obtaining a map data set that contains the route from a map database which stores a plurality of map data sets, based on the travel route data;
generating photography data which represents that the image data set was obtained at the photography location along the route; and
attaching the photography data to the map data set; wherein
the procedure of generating album data generates album data including the map data set, in which the photography data is correlated with the image data set.

18. A recording medium as defined in claim 16, wherein the program further comprises the procedure of:
obtaining related data, which is related to the photography location of the at least one image data set for which the distance is over the predetermined threshold value, based on the location data attached thereto, from a related data storage means which stores a plurality of related data sets; wherein
the procedure of generating album data generates album data, which includes the related data.

19. A recording medium as defined in claim 17, wherein the program further comprises the procedure of:
obtaining related data, which is related to the photography location of the at least one image data set for which the distance is over the predetermined threshold value, based on the location data attached thereto, from a related data storage means which stores a plurality of related data sets; wherein
the procedure of generating album data generates album data, which includes the related data.

20. A recording medium as defined in claim 16, wherein:
the procedure of generating album data generates album data according to predetermined themes, for the at least one image data set for which the distance is less than or equal to the predetermined threshold value.
